(19) United States
(12) Patent Application Publication
(10) Pub. No.: US 2025/0265635 A1
(43) Pub. Date: Aug. 21, 2025

(54) Predictive Model for Key Item Classification and Fulfillment

(71) Applicant: Maplebear Inc., San Francisco, CA (US)

(72) Inventors: Brent Scheibelhut, Toronto (CA); Charles Wesley, San Diego, CA (US)

(21) Appl. No.: 18/442,878

(22) Filed: Feb. 15, 2024

(51) Int. Cl. G06Q 30/0601; G06Q 10/0631; G06Q 10/087

(52) U.S. Cl. CPC G06Q 30/0637; G06Q 10/06311; G06Q 10/087; G06Q 30/0619

(57) ABSTRACT

An online system predicts key items for triggering a replacement workflow when determined to be unavailable. The online system receives, from a first client device associated with a first user, an order comprising a list of items to be obtained at the location by a second user. The online system applies a prediction model to the list of items to classify whether each item is a key item. Responsive to the prediction model classifying a first item as being a key item, the online system tags the first item as a key item. The online system transmits the list of items with the key item for display on a second client device associated with a second user. The online system receives a message from the second client device indicating that the key item is unavailable at the location. In response, the online system initiates a high-friction replacement workflow for the key item instead of a low-friction replacement workflow.

### BACKGROUND

In an online system, a first user, via a client device, may provide a list of items to be obtained at a location by a second user. In the process of obtaining the items at the location, the second user may encounter unavailable items in the list. In response to unavailable items, the second user may communicate to the first user, e.g., via respective client devices, regarding the unavailability of such items. Such communication can create a lag time, hindering the efficiency of the second user. Moreover, undesired substitution items may create dissatisfaction in the first user, thereby hindering the performance of the online system. Accordingly, there remains a need for improved user interfaces that can streamline such interplay to optimize efficiency of the online system's fulfillment.

### SUMMARY

An online system fulfills an order placed by a first user by dispatching a second user to a retail location to obtain items from the order. When an item is unavailable, the second user tries to find a suitable replacement item, and some items in an order may be deemed critical by the user such that an incorrect replacement results in a relatively high degree of dissatisfaction. To mitigate undesirable substitution items, the online system leverages a key item prediction model to classify whether items in an order are key items.

The online system trains the key item prediction model using historical orders by users of the online system. The online system may labels one or more of the items in the historical orders as key items, e.g., based on an ordering frequency of the item, feedback by the first user when a substitution item was obtained in lieu of the item, a response time of the first user when the replacement workflow is triggered, a uniqueness of the item, or some combination thereof. The online system may further implement a feedback loop that refines the key item prediction model based on user engagement when items are unavailable.

The online system can tag items classified as being key items when transmitting the list to the second user. In response to the second user indicating to the online system that the key item is unavailable, the online system can trigger a high-friction replacement workflow for key items instead of a low-friction replacement workflow for other items. In general, the high-friction replacement workflow includes one or more additional steps for the picker compared to the low-friction replacement workflow. Example steps may include, but are not limited to: prompting the picker to request replacement instructions urgently, prompting the picker to confirm the substitution item with the customer, prompting the picker to provide a picture confirmation of the substitution item, etc. The replacement workflow generally includes a prompt to the second user to initiate communication with the first user to request replacement instructions for the unavailable key item. The first user may provide the replacement instructions, which may include requesting to cancel the order, requesting to cancel the key item in the order, or providing an alternative item in lieu of an unavailable key item.

In additional embodiments, the online system can utilize the key classifications to modify how the items are displayed via a second client device associated with the second user. The modifications may include rearranging the items in the order, e.g., to place key items in higher positions. This would build in a time buffer to maximize the time for communication in scenarios where key items are unavailable at the retail location.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 illustrates a flow diagram of key item handling, in accordance with one or more embodiments.

FIG. 4 is a flowchart describing the process of key item handling, in accordance with one or more embodiments.

FIG. 5 is a flowchart describing the process of prediction model training, in accordance with one or more embodiments.

### DETAILED DESCRIPTION

### Online Concierge System Environment

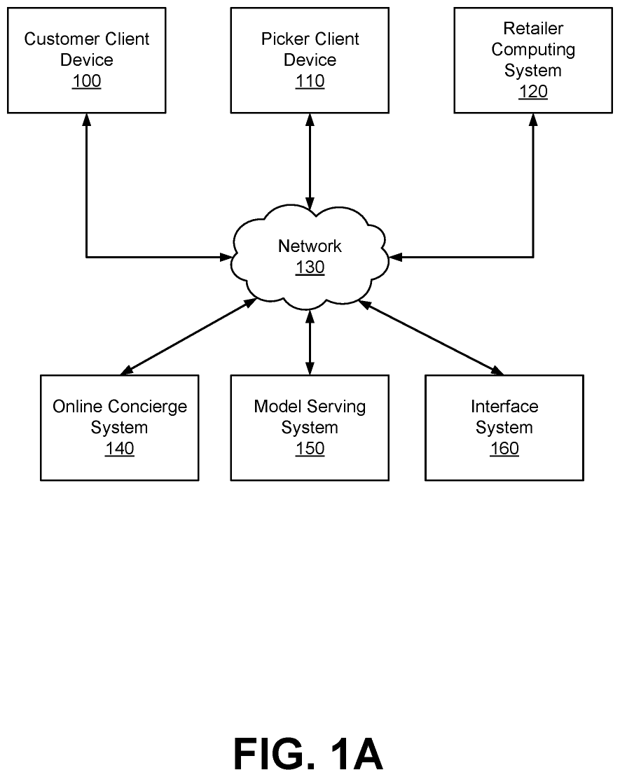

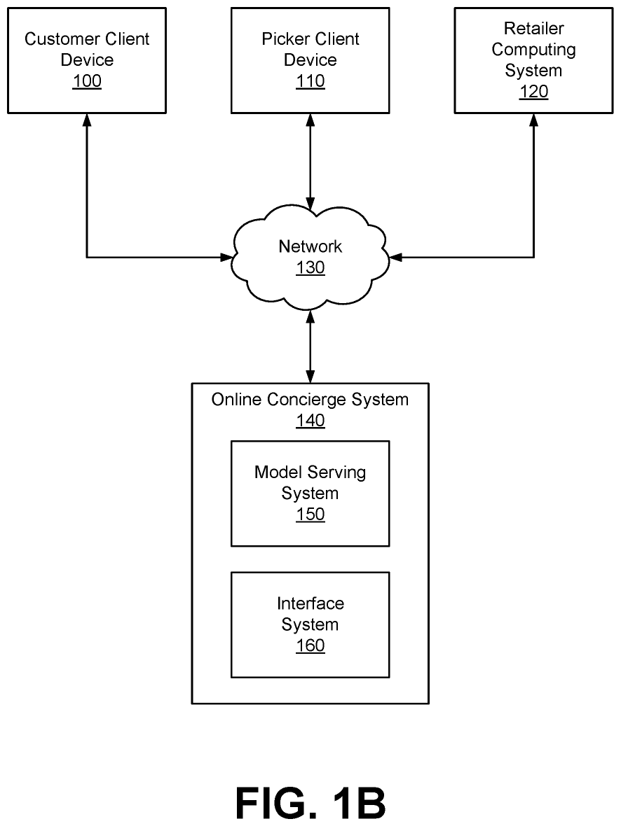

FIG. 1A illustrates an example system environment for an online concierge system 140, in accordance with one or more embodiments. The system environment illustrated in FIG. 1A includes a customer client device 100, a picker client device 110, a retailer computing system 120, a network 130, an online concierge system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good, a product, or a service that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140. To perform a search, the customer provides a query (e.g., a text query, an audio query, or a visual query) to the online concierge system 140. The online concierge system 140 processes the query to return query results to the customer. Based on the displayed results, the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected. The user interface may also include options to provide input for user preferences. For example, the customer may, via the user interface, provide input tagging one or more items as favorite items. In another example, the customer may, via the user interface, provide input (e.g., in the form of user feedback or user messages) to past orders.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. Items in the order may be presented in a particular sequence (i.e., display order) to optimize efficiency of the picker. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

The picker client device 110 may also provide a communication interface to the picker, e.g., to communicate with another user of the online concierge system 140. For example, the communication interface of the picker client device 110 may present messages from a customer client device 100 to the picker client device 110. Such communication may be utilized when items in an order are unavailable at the retailer location. In such scenarios, the picker may query the customer for suitable substitution items to be obtained for the unavailable item. The messages may be in the form of text, audio, pictures, other digital manners of communicating information, etc.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The retailer computing system 120 may provide the online concierge system 140 with retailer data describing the retailer associated with the retailer computing system 120. For example, the retailer computing system 120 may provide retailer data including, but not limited to: retailer name, retailer address, retailer website, retailer phone number, other identifying information, a type of retailer, an expense class of the retailer (e.g., $, $$, or $$$), opening hours, general dependability of items, diversity of items, types of items carried, or information describing the retailer, or some combination thereof. The online concierge system 140 may further infer additional retailer data based on interactions between customers or shoppers and the retailer. For example, such retailer data based on the interactions may include customer reviews, shopper reviews, popular items ordered, dependability of items, etc.

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online concierge system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

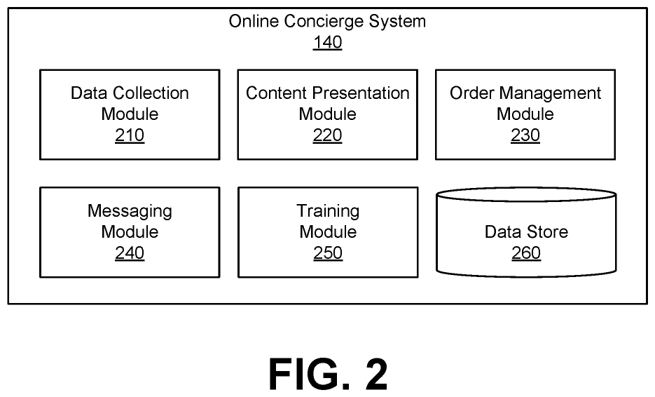

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140. The online concierge system 140 is described in further detail below with regards to FIG. 2.

### Online Concierge System Architecture

FIG. 2 illustrates an example system architecture for an online concierge system 140, in accordance with some embodiments. The system architecture illustrated in FIG. 2 includes a data collection module 210, a content presentation module 220, an order management module 230, a messaging module 240, a training module 250, a data store 260, a prompt generation module 250, and a ranking module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online concierge system 140 and stores the data in the data store 260. The data collection module 210 may only collect data describing a user if the user has previously explicitly consented to the online concierge system 140 collecting data describing the user. Additionally, the data collection module 210 may encrypt all data, including sensitive or personal data, describing users.

For example, the data collection module 210 collects customer data, which is information or data that describe characteristics of a customer. The data collection module 210 may collect customer data including, but not limited to: a customer's name, address, other demographic information (e.g., age range, family size, dietary restrictions or preferences, etc.), shopping preferences (e.g., shopping frequency, shopping magnitude, etc.), previous orders, favorite items, favorite types of items, favorite retailers, or stored payment instruments. The customer data also may include default settings established by the customer, such as a default retailer/retailer location, payment instrument, delivery location, or delivery timeframe. The customer data may also include user preference data indicating one or more preferences, e.g., provided by the user and/or inferred by the online concierge system 140. The data collection module 210 may collect the customer data from sensors on the customer client device 100 or based on the customer's interactions with the online concierge system 140.

The data collection module 210 also collects item data, which is information or data that identifies and describes items that are available at a retailer location. The data collection module 210 may collect item data including, but not limited to: item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in retailer locations, also referred to as “dependability.” For example, for each item-retailer combination (a particular item at a particular warehouse), the item data may include a time that the item was last found, a time that the item was last not found (a picker looked for the item but could not find it), the rate at which the item is found, or the popularity of the item. The data collection module 210 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 210 also collects picker data, which is information or data that describes characteristics of pickers. For example, the data collection module 210 may collect picker data for a picker including, but not limited to: the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, payment information by which the picker is to be paid for servicing orders (e.g., a bank account), feedback from the picker in fulfilling customer orders, etc. The data collection module 210 collects picker data from sensors of the picker client device 110 or from the picker's interactions with the online concierge system 140.

Additionally, the data collection module 210 collects order data, which is information or data that describes characteristics of an order. For example, the data collection module 210 may collect order data including, but not limited to: item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 220 selects content for presentation to a user. For example, the content presentation module 220 selects which items to present to a customer while the customer is placing an order. The content presentation module 220 generates and transmits an ordering interface for the customer to order items. The content presentation module 220 populates the ordering interface with items that the customer may select for adding to their order. In some embodiments, the content presentation module 220 presents a catalog of all items that are available to the customer, which the customer can browse to select items to order. The content presentation module 220 also may identify items that the customer is most likely to order and present those items to the customer. For example, the content presentation module 220 may score items and rank the items based on their scores. The content presentation module 220 displays the items with scores that exceed some threshold (e.g., the top n items or the p percentile of items).

The content presentation module 220 may use a scoring function to score items for presentation to a customer. The scoring function may score items for a customer based on item data for the items and customer data for the customer. The scoring function may determine a ranking score based on ranking parameter values for each item and a weight vector. In some embodiments, an item selection model trained as a machine-learning model may determine a likelihood that the customer will order the item. In some embodiments, the item selection model uses item embeddings describing items and customer embeddings describing customers to score items. These item embeddings and customer embeddings may be generated by separate machine-learning models and may be stored in the data store 260.

The content presentation module 220 also presents content to the picker. The content presented to the picker may include orders to be fulfilled by the picker. Each order includes a list of one or more items to be obtained at a retailer location. The content presentation module 220 applies a key item prediction model to a list of items in an order to classify each item into one of a plurality of labels including at least a key item label. The plurality of labels may include two, three, four, five, or more labels. In one example, the key item prediction model may classify between two labels: a key item label and a regular item label. In another example, the key item prediction model may classify between three labels: a key item label, a regular item label (i.e., an item not deemed to be a key item but with a low number of available alternatives), and a generic item label (i.e., an item that has a high number of available alternatives). Based on the classification, the content presentation module 220 may tag items classified into the key item label as key items. Tagging may include providing a visual indicator adjacent to the key item, e.g., “Key,” “High-Priority,” “Critical,” or “Important.”

Key items trigger a high-friction replacement workflow when the key items are found to be unavailable, as compared to a low-friction replacement workflow for regular items or generic items. The high-friction replacement workflow includes one or more additional steps for the picker compared to the low-friction replacement workflow. Example steps may include, but are not limited to: prompting the picker to request replacement instructions urgently, prompting the picker to confirm the substitution item with the customer, prompting the picker to confirm satisfaction by the customer early in the order fulfillment, prompting the picker to provide a picture confirmation of the substitution item, etc. In general, a replacement workflow may include prompting the picker to initiate communication with the customer to obtain replacement instructions for the unavailable tagged item. When the picker, via the picker's client device, indicates that the key item is unavailable, the content presentation module may provide a prompt to the picker, via the picker's device, to initiate communication with the customer, via the customer's device.

In other embodiments, the content presentation module 220 may modify how the list of items is displayed on the picker's device based on the key items. For example, the content presentation module 220 may prioritize the key items, e.g., placing such items higher in the display queue when presented to the picker, other visual manners of distinguishing the key items, prompting the picker to provide confirmation to the customer when obtaining the key items, or some combination thereof.

In some embodiments, the content presentation module 220 further orders the list of items according to contextual data regarding the order. For example, contextual data may include, but is not limited to, the retailer location, wait times at the retailer location, position of items in the retailer location, response time of the customer (e.g., fast, medium, or slow), when the order is to be fulfilled (e.g., urgent delivery, or 3-day order ahead), other characteristics describing the user engagement with the order, etc. In such embodiments, the content presentation module 220 may utilize a display function that disparately weights the predicted labels against the other contextual data. For example, the display function may seek to prioritize optimizing the picker's route such that items are displayed to navigate the picker on the optimal route.

The content presentation module 220 may train the key item prediction model based on historical order data by users of the online system and user satisfaction with those orders. The key item prediction model may be further trained on user preference data and/or user engagement data with past orders.

The content presentation module 220 obtains historical orders (e.g., past lists of ordered items) and may label one or more of the items from the historical orders as key items. The content presentation module 220 trains the key item prediction model with the labels of the various items. The key item prediction model may be trained so as to predict the label for previously unlabeled items. As additional orders are fulfilled by the online concierge system 140, the content presentation module 220 may further refine the key item prediction model with updated or novel labels for items ordered. In one or more embodiments, the key item prediction model is trained as a machine-learning model.

The content presentation module 220 may also classify items based on additional criteria. In some embodiments, the content presentation module 220 may assign label the items in historical orders based on user preference data and/or user engagement data for a population of users of the online concierge system 140. For example, a majority of users may be particular with a flavor of ice cream, such that ice cream may be weighted towards being assigned the key item label. In other embodiments, the content presentation module 220 may assign the labels based on a uniqueness of the item. For example, a small-batch locally-crafted beverage may be assigned the key item label over generic mass-manufactured drinks. In other embodiments, the complexity of an item may push the assignment towards the key item label. For example, a particular brand of a dozen of eggs may be assigned the key item label, whereas a more commonly ordered (and perhaps cheaper) dozen of eggs is assigned another label (e.g., regular item). In other embodiments, the label assignment of items may be based on learned relations between items. For example, a particular set of items may be assigned the key item label for being part of a particular recipe. As another example, a customer frequently pairs a particular wine with a particular cheese, such that the two items are correlated in the user preference data. In other embodiments, a position of the item when added to the order may influence the label assignment of the item, e.g., inferring that items added earlier are more likely to be key items than items added later.

The user preference data may include favorite items, response time of the user, item category preferences, particularity of the user, etc. As described elsewhere, the user preference data may be input by the user or may be inferred by the online concierge system 140. For example, the online concierge system 140 may infer that an item is a favorite item based on a frequency that the customer orders the particular item. The item may also be tagged as a favorite item based on the user input.

The user engagement data may include the responsiveness of a user to queries by the picker for unavailable items, or the feedback provided by a user to a substitution item obtained in place for an unavailable item. For example, if the customer engages in a lengthy conversation with the picker regarding unavailability of a particular item, the content presentation module 220 can infer that the particular item is a key item. In another example, if the customer provides negative feedback to a substitution item, then the content presentation module 220 can infer that the particular item is key and that the customer is not as flexible with alternatives. In yet another example, if the customer subsequently cancels an order based on the unavailability of an item, then the content presentation module 220 can infer that the particular item is key.

The order management module 230 manages orders for items from customers. The order management module 230 receives orders from a customer client device 100 and assigns the orders to pickers for service based on picker data. For example, the order management module 230 assigns an order to a picker based on the picker's location and the location of the retailer from which the ordered items are to be collected. The order management module 230 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 230 determines when to assign an order to a picker based on a delivery timeframe requested by the customer with the order. The order management module 230 computes an estimated amount of time that it would take for a picker to collect the items for an order and deliver the ordered items to the delivery location for the order. The order management module 230 assigns the order to a picker at a time such that, if the picker immediately services the order, the picker is likely to deliver the order at a time within the requested timeframe. Thus, when the order management module 230 receives an order, the order management module 230 may delay in assigning the order to a picker if the requested timeframe is far enough in the future (i.e., the picker may be assigned at a later time and is still predicted to meet the requested timeframe).

When the order management module 230 assigns an order to a picker, the order management module 230 transmits the order to the picker client device 110 associated with the picker, e.g., with the content presentation module 220. The order management module 230 may also transmit navigation instructions from the picker's current location to the retailer location associated with the order. If the order includes items to collect from multiple retailer locations, the order management module 230 identifies the retailer locations to the picker and may also specify a sequence in which the picker should visit the retailer locations.

The order management module 230 may track the location of the picker through the picker client device 110 to determine when the picker arrives at the retailer location. When the picker arrives at the retailer location, the order management module 230 transmits the order to the picker client device 110 for display to the picker. As the picker uses the picker client device 110 to collect items at the retailer location, the order management module 230 receives item identifiers for items that the picker has collected for the order. In some embodiments, the order management module 230 receives images of items from the picker client device 110 and applies computer-vision techniques to the images to identify the items depicted by the images. The order management module 230 may track the progress of the picker as the picker collects items for an order and may transmit progress updates to the customer client device 100 that describe which items have been collected for the customer's order.

In some embodiments, the order management module 230 tracks the location of the picker within the retailer location. The order management module 230 uses sensor data from the picker client device 110 or from sensors in the retailer location to determine the location of the picker in the retailer location. The order management module 230 may transmit, to the picker client device 110, instructions to display a map of the retailer location indicating where in the retailer location the picker is located. Additionally, the order management module 230 may instruct the picker client device 110 to display the locations of items for the picker to collect, and may further display navigation instructions for how the picker can travel from their current location to the location of a next item to collect for an order.

The order management module 230 determines when the picker has collected all of the items for an order. For example, the order management module 230 may receive a message from the picker client device 110 indicating that all of the items for an order have been collected. Alternatively, the order management module 230 may receive item identifiers for items collected by the picker and determine when all of the items in an order have been collected. When the order management module 230 determines that the picker has completed an order, the order management module 230 transmits the delivery location for the order to the picker client device 110. The order management module 230 may also transmit navigation instructions to the picker client device 110 that specify how to travel from the retailer location to the delivery location, or to a subsequent retailer location for further item collection. The order management module 230 tracks the location of the picker as the picker travels to the delivery location for an order, and updates the customer with the location of the picker so that the customer can track the progress of the order. In some embodiments, the order management module 230 computes an estimated time of arrival of the picker at the delivery location and provides the estimated time of arrival to the customer.

The order management module 230 coordinates payment by the customer for the order. The order management module 230 uses payment information provided by the customer (e.g., a credit card number or a bank account) to receive payment for the order. In some embodiments, the order management module 230 stores the payment information for use in subsequent orders by the customer. The order management module 230 computes a total cost for the order and charges the customer that cost. The order management module 230 may provide a portion of the total cost to the picker for servicing the order, and another portion of the total cost to the retailer.

The messaging module 240 facilitates communication between the customer client device 100 and the picker client device 110. As noted above, a customer may use a customer client device 100 to communicate with a picker via the picker client device 110. The messaging module 240 receives the message from the customer client device 100 and transmits the message to the picker client device 110 for presentation to the picker. The picker may use the picker client device 110 to send a message to the customer client device 100 in a similar manner. Communications between the customer and the picker may be provided to the content presentation module 220 in determining label assignment. In the high-friction replacement workflow, upon receiving the initiation of communication, the messaging module 240 may establish the communication between the picker's device and the customer's device. Through the established communication, the customer may provide replacement instructions to the picker. Such instructions may include canceling of the order, canceling of that item in the order, or providing an alternative item to be obtained in lieu of the unavailable tagged item.

The training module 250 trains machine-learning models used by the online concierge system 140. For example, the training module 250 may train the item selection model, the dependability model, the query processing model(s), the key item prediction model, or any of the machine-learned models deployed by the model serving system 150. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 250 generates the set of parameters (e.g., the particular values of the parameters) for a machine-learning model by “training” the machine-learning model. Once trained, the machine-learning model uses the set of parameters to transform inputs into outputs.

The training module 250 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 250 may apply an iterative process to train a machine-learning model whereby the training module 250 updates parameter values of the machine-learning model based on each of the set of training examples. The training examples may be processed together, individually, or in batches. To train a machine-learning model based on a training example, the training module 250 applies the machine-learning model to the input data in the training example to generate an output based on a current set of parameter values. The training module 250 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 250 updates the set of parameters for the machine-learning model based on the score generated by the loss function. For example, the training module 250 may apply gradient descent to update the set of parameters.

The data store 260 stores data used by the online concierge system 140. For example, the data store 260 stores customer data, retailer data, item data, order data, and picker data for use by the online concierge system 140. The data store 260 also stores trained machine-learning models trained by the training module 250. For example, the data store 260 may store the set of parameters for a trained machine-learning model on one or more non-transitory, computer-readable media. The data store 260 uses computer-readable media to store data, and may use databases to organize the stored data.

With respect to the machine-learned models hosted by the model serving system 150, the machine-learned models may already be trained by a separate entity from the entity responsible for the online concierge system 140. In one or more other embodiments, when the model serving system 150 is included in the online concierge system 140, the training module 250 may further train parameters of the machine-learned model based on data specific to the online concierge system 140 stored in the data store 260. As an example, the training module 250 may obtain a pre-trained transformer language model and further fine tune the parameters of the transformer model using training data stored in the data store 260. The training module 250 may provide the model to the model serving system 150 for deployment.

### Key Item Handling

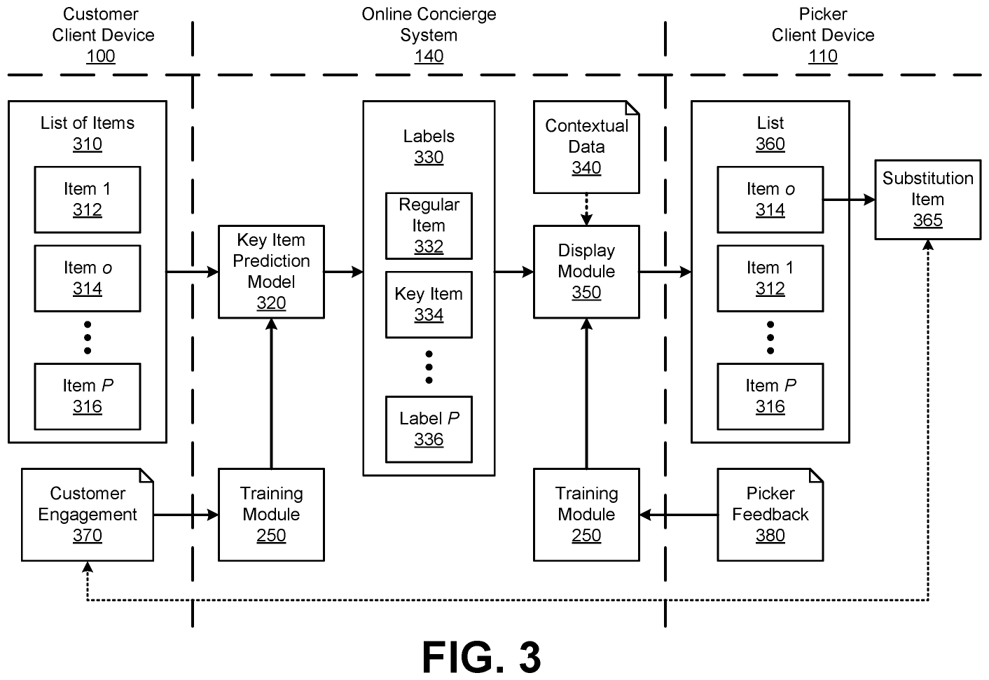

FIG. 3 illustrates a flow diagram of key item handling, in accordance with one or more embodiments. The online concierge system 140 receives an order by the customer client device 100 including a list of items to be obtained by the picker. The online concierge system 140 applies a key item prediction model 320 to classify each item into one of a plurality of labels, including a key item label. The online concierge system 140 may tag items classified into the key item label when presenting the items to the picker client device 110. In one or more embodiments, the key item prediction model 320 and the display module 350 are components of the content presentation module 220.

The customer client device 100 provides an order to the online concierge system 140. The order includes a list of items 310 to be obtained by a picker at a particular retailer location. The list of items 310 includes, for example Item 1 312, Item o 314, through Item P 316, wherein P refers to a total number of items ordered by the customer client device 100, and wherein o is a natural number selected from the range of [1, P]. The order may further include tags for one or more foundational items in the order. For example, the ordering interface presented on the customer client device 100 may include options to tag one or more items in the order as key items.

The online concierge system 140 applies the key item prediction model 320 to the list of items 310 to determine a label 330 for each item. For example, Item 1 312 receives a Regular Item 332 label, Item o 314 receives a Key Item 334 label, through Item P 316 receiving Label P 336. The labels 330 may be from the set of labels, e.g., critical and non-critical.

The online concierge system 140 may tag Item o 314 as a key item. The tagging into an ordered list 360 for presentation to the picker client device 110. The tagged Item o 314 will trigger the high-friction replacement workflow if the item is determined by the picker to be unavailable. In one or more embodiments, the display module 350 orders the items based on their labels 330. For example, the items are ordered in descending label order. In other embodiments, the display module 350 may order the items further based on contextual data 340. For example, if a retailer location has very short wait times, then the display module 350 may place the key items at the top of the ordered list 360 to maximize time for the picker and the customer to communicate in the scenarios where the key items are unavailable. As another example, if the customer has a very low response rate, the display module 350 may display the items to optimize a route of the picker rather than reordering the items to display the key items at the top.

The picker client device 110 receives and presents the ordered list 360 to the picker. In such embodiments, Item o 314 was placed at the top of the ordered list 360, e.g., due to being classified as a key item. The picker, in obtaining Item o 314, may determine that the item is unavailable at the retailer location. The picker may engage in communication with the customer to notify the customer of the unavailability of Item o 314. The customer client device 100 may provide customer engagement 370 in response to the picker client device 110 notifying the customer client device 100 of unavailability of the item. In some embodiments, the customer engagement 370 includes replacement instructions. The replacement instructions may include canceling the order, canceling the item in the order, or providing a substitution item in lieu of the unavailable tagged item. The customer engagement 370 may further include customer feedback regarding the substitution item 365 chose in lieu of the Item o 314. In some embodiments, based on the labels 330, the display module 350 may include a prompt to further engage with the customer regarding a key item label tagged item. The prompt may prompt the picker to, e.g., confirm obtaining of the key item (optionally, with a photo), notify the user of unavailability, request alternatives, further engage the customer, etc. In place of the unavailable Item o 314, the picker may obtain a substitution item 365.

The picker may also provide picker feedback 380 to the online concierge system 140 via the picker client device 110. The picker feedback 380 may provide feedback on the ordered list 360 or other prompts provided by the online concierge system 140 to the picker client device 110. For example, the picker feedback 380 may indicate that the ordered list 360 caused a lot of redundant movement, e.g., moving back and forth between two sections of the retailer location, thereby cutting into efficiency in fulfillment of the order.

The online concierge system 140 may further train the key item prediction model 320 based on the customer engagement 370. The online concierge system 140 may utilize the customer engagement 370 to assign labels to items in historical orders fulfilled by the online concierge system 140 for the customer client device 100. Based on the label assignments, the training module 250 may train and/or retrain the key item prediction model 320 to predict labels. For example, the key item prediction model 320 may classify that one item in an order is a key item, but customer engagement 370 indicated otherwise (or vice versa, item predicted not to be a key item, but customer engagement 370 indicated otherwise). The online concierge system 140 may correct the label for the item and retrain the key item prediction model 320 with the incorrectly classified item. The online concierge system 140 may also tune the display module 350 based on picker feedback 380. The picker feedback 380 may aid in tuning weights of the display function, e.g., to prioritize key items or to prioritize optimizing the picker's route, etc.

### Exemplary Methods

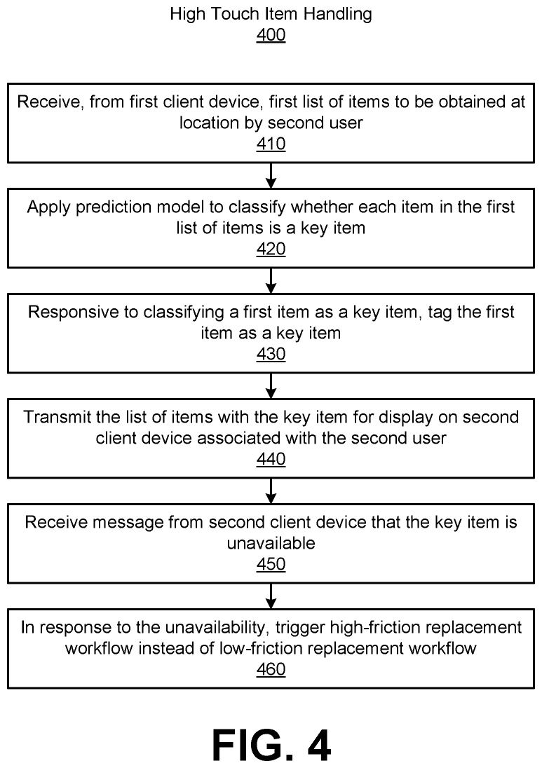

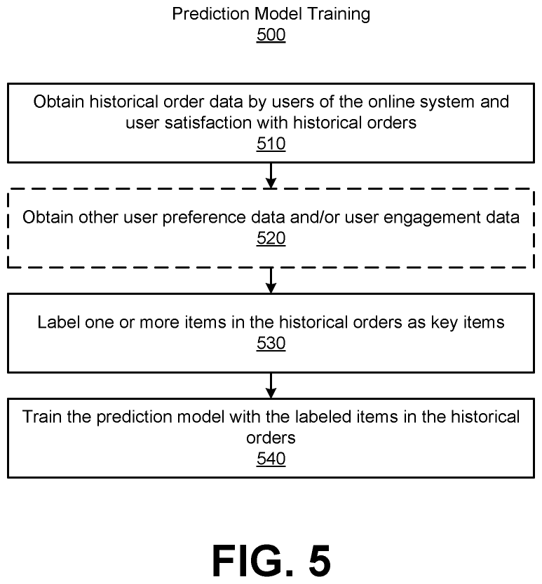

FIGS. 4 & 5 are flowcharts describing methods related to key item handling, in accordance with one or more embodiments. In particular, FIG. 4 describes deployment of the key item prediction model to trigger a high-friction replacement workflow for key items. FIG. 5 describes training of the key item prediction model based on historical order data and user satisfaction data associated therewith. The descriptions of FIGS. 4 & 5 are in the perspective of an online system (e.g., the online concierge system 140), but in other embodiments, any computing system or device may perform any, some, or all of the steps.

FIG. 4 is a flowchart describing the process of key item handling 400, in accordance with one or more embodiments.

The online system receives 410, from a first client device associated with a first user, a list of items to be obtained at a location by a second user. The list of items may be part of an order to be fulfilled by the online system. The location may be a retailer location storing one or more of the items to be obtained by the second user. The list of items may indicate one or more items as key items, e.g., by the first user.

The online system applies 420 a prediction model to classify whether each item in the first list of items is a key item. The key item label indicates a high degree of importance of the item to the first user. The labels include at least a key item label, and may include additional degrees of importance (e.g., regular item, generic item). In one or more embodiments, the prediction model classifies a first item into the key item label.

Responsive to classifying the first item into the key item label, the online system tags 430 the first item as a key item. The tagged item may trigger the high-friction replacement workflow when the tagged item is determined to be unavailable by the picker.

The online system transmits 440 the list of items with the key item for display on a second client device associated with the second user. The second user may be a shopper or picker that obtains items in the first list of items. As noted above, the key item may trigger the high-friction replacement workflow when the key item is determined to be unavailable by the picker. The list of items may further be arranged based on label classification. The display order optimizes the improvement in fulfilling orders by the online system as the second user is afforded maximum time to engage the first user in scenarios where key items are unavailable at the location. The online system may further determine the display order based on other contextual data, e.g., using a display function that disparately weights influence of the classification labels and the other contextual data in determining the display order. For example, other contextual data may include the retailer location, wait time at the retailer location, response quickness of the first user, position of the items in the retailer location, urgency of fulfillment of the order, etc.

In some embodiments, the online system may add prompts to key items in the first list of items. The prompts prompt the second user to perform some action in relation to the key items. For example, a first prompt can prompt the second user to provide a message confirmation of obtaining the key item. As another example, another prompt can prompt the second user to query the first user for suitable substitution items prior to obtaining the substitution item in place of the unavailable key item.

The online system receives 450 a message from the second client device associated with the picker that the key item is unavailable. Whilst obtaining the items in the list, the picker may have identified the key item as unavailable.

In response to the unavailability, the online system triggers 460 a high-friction replacement workflow. The high-friction replacement workflow, when compared to a low-friction replacement workflow, may include one or more additional steps, e.g., prompting the second client device to initiate communication with the first client device to obtain replacement instructions early, prompting the second client device to receive first client approval before checking out. The second client device may request establishment of the communication, through which the first client device may communicate replacement instructions.

FIG. 5 is a flowchart describing the process of prediction model training 500, in accordance with one or more embodiments.

The online system obtains 510 historical order data by users of the online system and user satisfaction with the historical orders. The historical order data includes past orders including lists of items and, optionally, substitution items obtained in lieu of unavailable items. Some of the historical orders may provide user feedback, e.g., including feedback related to substitution items.

The online system may also obtain 520 user preference data and/or other user engagement data. For example, user preference data may include items favorited by users, or frequently viewed by users. The user preference data may further include one or more preferences provided by the user, or inferred by the online system. The user engagement may include communications between the first user and the other users obtaining the items at the location. Other user engagement data may include data on user's canceling or otherwise modifying orders based on unavailability of items.

The online system labels 530 one or more of the items in the historical orders as key items, based on user satisfaction. The label for an item indicates an importance of the item to the order and/or the customer. In one example, the label for an item may be determined based on the item's frequency on historical lists. In another example, the label for an item may be determined according to amount of user engagement regarding the item. In yet another example, the priority score for an item may be determined if the item is favorited by the user, i.e., is preferred by the user.

The online system trains 540 the prediction model with the labels of the items in the historical lists. The prediction model may be trained as a machine-learning model. The prediction model may be trained to be tailored to the first user, e.g., based on the first user's favorited items. In general, the prediction model may be trained to learn how the population of users prioritizes items. The trained prediction model inputs a list of items and classifies whether each item is a key item.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method comprising:
receiving, from a first client device associated with a first user of an online system, an order comprising a list of items to be obtained at a retailer location by a second user;
applying a prediction model to each item in the list of items to classify whether each item is a key item, wherein the prediction model classifies whether an item in an order is a key item for the order, and wherein the prediction model is trained by:
retrieving historical order data for a plurality of users of the online system, the historical order data including one or more historical orders and user satisfaction with the orders,
labeling one or more items in the one or more historical orders as being key items, and
training the prediction model with the historical order data and the labels;
responsive to the prediction model classifying a first item in the order as being a key item, tagging the first item as a key item;
transmitting the list of items for display on a second client device associated with the second user, wherein the second user is assigned to fulfill the order;
receiving, from the second client device, a message indicating that the key item is unavailable at the retailer location; and
in response to receiving the message, triggering a high-friction replacement workflow for the key item, wherein the high-friction replacement workflow includes, as compared to a low-friction workflow, one or more additional steps to fulfill the order.

2. The computer-implemented method of claim 1, wherein labeling the one or more items in the one or more historical orders as being key items is based in part on a frequency of each item in the one or more historical orders.

3. The computer-implemented method of claim 1, wherein labeling the one or more items in the one or more historical orders as being key items comprises labeling at least a first item in the one or more historical orders as a key item based in part on user feedback for a substitution item obtained in lieu of the first item in the one or more historical orders.

4. The computer-implemented method of claim 1, wherein labeling the one or more items in the one or more historical orders as being key items is based in part on a response time in communications between an order requesting user and an order fulfillment user regarding the one or more items in the one or more historical orders.

5. The computer-implemented method of claim 1, wherein labeling the one or more items in the one or more historical orders as being key items is based in part on a uniqueness of each item in the one or more historical orders.

6. The computer-implemented method of claim 5, wherein the uniqueness of each item is based on one or more of:
user feedback on substitution items obtained in lieu of the item,
user responsiveness to communications regarding the item,
an inventory count of the item, and
a complexity of the item.

7. The computer-implemented method of claim 1, wherein triggering the high-friction replacement workflow comprises triggering one or more of:
prompting the second user to request replacement instructions early;
prompting the second user to confirm approval of a substitution item with the first user prior to order completion; and
prompting the second user to provide a picture confirmation of availability of the substitution item.

8. The computer-implemented method of claim 7, further comprising:
receiving the replacement instructions to obtain an alternative item to be obtained in lieu of the key item.

9. The computer-implemented method of claim 1, wherein tagging the first item as a key item comprises displaying a visual indicator adjacent to the key item.

10. The computer-implemented method of claim 1, wherein tagging the first item as a key item comprises prompting the second user to provide confirmation to the first client device upon obtaining the key item at the retailer location.

11. The computer-implemented method of claim 1, further comprising:
receiving, from the first client device, feedback associated with fulfillment of the order with the triggered high-friction replacement workflow;
labeling items in the order based on the feedback; and
retraining the prediction model with the labeled items.

12. A non-transitory computer-readable storage medium storing instructions that, when executed by a computer processor, cause the computer processor to perform operations comprising:
receiving, from a first client device associated with a first user of an online system, an order comprising a list of items to be obtained at a retailer location by a second user;
applying a prediction model to each item in the list of items to classify whether each item is a key item, wherein the prediction model classifies whether an item in an order is a key item for the order, and wherein the prediction model is trained by:
retrieving historical order data for a plurality of users of the online system, the historical order data including one or more historical orders and user satisfaction with the orders,
labeling one or more items in the one or more historical orders as being key items, and
training the prediction model with the historical order data and the labels;
responsive to the prediction model classifying a first item in the order as being a key item, tagging the first item as a key item;
transmitting the list of items for display on a second client device associated with the second user, wherein the second user is assigned to fulfill the order;
receiving, from the second client device, a message indicating that the key item is unavailable at the retailer location; and
in response to receiving the message, triggering a high-friction replacement workflow for the key item, wherein the high-friction replacement workflow includes, as compared to a low-friction workflow, one or more additional steps to fulfill the order.

13. The non-transitory computer-readable storage medium of claim 12, wherein labeling the one or more items in the one or more historical orders as being key items is based in part on a frequency of each item in the one or more historical orders.

14. The non-transitory computer-readable storage medium of claim 12, wherein labeling the one or more items in the one or more historical orders as being key items comprises labeling at least a first item in the one or more historical orders as a key item based in part on user feedback for a substitution item obtained in lieu of the first item in the one or more historical orders.

15. The non-transitory computer-readable storage medium of claim 12, wherein labeling the one or more items in the one or more historical orders as being key items is based in part on a response time in communications between an order requesting user and an order fulfillment user regarding the one or more items in the one or more historical orders.

16. The non-transitory computer-readable storage medium of claim 12, wherein labeling the one or more items in the one or more historical orders as being key items is based in part on a uniqueness of each item in the one or more historical orders.

17. The non-transitory computer-readable storage medium of claim 16, wherein the uniqueness of each item is based on one or more of:
user feedback on substitution items obtained in lieu of the item,
user responsiveness to communications regarding the item,
an inventory count of the item, and
a complexity of the item.

18. The non-transitory computer-readable storage medium of claim 12, wherein triggering the high-friction replacement workflow comprises triggering the one or more of:
prompting the second user to request replacement instructions early;
prompting the second user to confirm approval of a substitution item with the first user prior to order completion; and
prompting the second user to provide a picture confirmation of availability of the substitution item.

19. The non-transitory computer-readable storage medium of claim 18, the operations further comprising:
receiving the replacement instructions to obtain an alternative item to be obtained in lieu of the key item.

20. The non-transitory computer-readable storage medium of claim 12, the operations further comprising:
receiving, from the first client device, feedback associated with fulfillment of the order with the triggered high-friction replacement workflow;
labeling items in the order based on the feedback; and
retraining the prediction model with the labeled items in the order.
